(19) United States
(12) Patent Application Publication
(10) Pub. No.: US 2006/0067381 A1
(43) Pub. Date: Mar. 30, 2006

(54) Spectrum re-use employing transfer domain communications systems

(76) Inventors: Vasu D. Chakravarthy, Beavercreek, OH (US); James P. Stephens, Bellbrook, OH (US); Arnab K. Shaw, Dayton, OH (US); Michael A. Temple, Huber Heights, OH (US)

Correspondence Address: DINSMORE & SHOHL LLP;One Dayton Centre, Suite 1300, One South Main Street, Dayton, OH, 45402-2023, US

(21) Appl. No.: 11/234,298

(22) Filed: Sep. 23, 2005

Related U.S. Application Data
(60) Provisional application No. 60/612,335, filed on Sep. 23, 2004.

(51) Int. Cl. H04B 1/69

(52) U.S. Cl. 375/130

(57) ABSTRACT

A system and method for spectrum re-use employing transfer domain communications systems is disclosed. An adaptive waveform technique reconfigures its fundamental modulation waveform depending on the spectral environment. Spectral interference, or other friendly user's presence, is estimated using general spectral estimation techniques. Once the frequency bands containing strong interference or signals of other users are identified, those frequency bands are removed prior to creating a time-domain Fundamental Modulation Waveform (FMW) using the appropriate inverse transform. The data is then modulated with these fandamental modulation waveforms to generate the digitally encoded waveforms. The digitally encoded waveforms representing the transmitted communication symbols do not contain energy at the spectral location of the interference. By repeating the spectral estimation and fundamental modulation waveform generation process, an adaptive waveform is created which adapts to the electromagnetic environment as needed.

### CROSS-REFERENCE TO RELATED APPLICATIONS

This application claims the benefit of U.S. Provisional Application Ser. No. 60/612,335, filed Sep. 23, 2004.

### STATEMENT REGARDING FEDERALLY SPONSORED RESEARCH OR DEVELOPMENT

This invention was made with government support under Contract No. ______ awarded by ______. The Government has certain rights in this invention.

### TECHNICAL FIELD

The present invention relates to Transfer Domain Communication Systems and, more particularly to the use of Transfer Domain Communication Systems for simultaneous spectrum sharing of multiple systems operating in the same spectral and spatial environment.

### BACKGROUND OF THE INVENTION

With the introduction of every new communications application, the radio frequency (RF) spectrum becomes more congested. Even though the Federal Communications Commission (FCC) has expanded some unlicensed spectral bands, the present system uses the procedure formulated in 1920 where different frequency bands are assigned to different users or service providers and licenses are required to operate within those bands. On average only ten percent of the allocated spectrum in the United States is in use at any given moment. To exploit unused spectrum more efficiently in dynamic environments, it is desirable for communication systems to adapt to a rapidly changing environment while ensuring there is no, or at least manageable, interference induced to existing users. Given that such systems employ active monitoring of spectral regions of interest, they can also be used to effectively avoid intentional interference.

Traditionally, communication waveforms are synthesized in time domain using preset frequency allocations to the user. If interference is present, it can be mitigated using real-time transform domain filtering techniques to provide interference suppression. Such techniques can be traced back to where primary responsibility for achieving Signal-to-Noise Ratio (SNR) improvement rested on the receiver. Subsequent advances in processing power have enabled more computationally intense techniques whereby SNR improvement is achieved synergistically through transmit/receive waveform diversity to provide interference avoidance. The basic idea behind Fundamental Modulation Waveform (FMW) generation is to avoid existing users, or jammers, by operating dynamically over a given bandwidth. Since the adaptive FMW is synthesized in the Transform Domain (TD), it is also referred to as Transfer Domain Communication Systems (TDCS).

TDCS concepts were initially proposed in a technical report in 1988 for a system which uses spectral information to modify a Direct Sequence Spread Spectrum (DS-SS) waveform to avoid jammed frequencies. Later in 1991, a conceptual Low Probability of Intercept (LPI) Communication System for hiding the transmitted signal in noise using transform domain signal processing was patented (U.S. Pat. No. 5,029,184). Conventional time-domain matched filtering and Maximum Likelihood (ML) detection are used at the receiver. Most previous research has focused on achieving TDCS multiple access capability while maintaining reliable performance in the presence of jamming. The key idea behind TDCS is to synthesize smart waveforms at the transmitter to provide an interference avoidance capability. In TDCS processing, interference suppression begins at the transmitter by avoiding the corrupted spectral regions due to interference. Avoiding interference at the transmitter has improved the performance of the system, but it has also added extra complexity to the transmitter.

A need exists for putting more than one system or application in the same spectral band, where the dynamic assignment of the Fundamental Modulation Waveform provides a new secure data link while ensuring that minimal, or at least manageable, interference is added to the existing users.

Another need exists for spectrum sharing that increases communication resources that at the same time decrease the spectral redundancy by efficiently using all of the allocated spectrum.

Yet another need exists for an adaptive waveform processing technique that adapts to environmental conditions via spectral synthesis of an adaptive fundamental modulation waveform.

### BRIEF SUMMARY OF THE INVENTION

These needs are met by the embodiments of the present invention in which an adaptive waveform technique reconfigures its Fundamental Modulation Waveform (FMW) depending on the spectral environment. Previous TDCS concepts were used to avoid interference at the transmitter instead of a more traditional way of mitigating interference at the receiver. In a basic TDCS implementation, spectral interference and friendly signal presence is estimated using Fourier-based or general spectral estimation techniques. Once frequency bands containing interference or other signals are identified, typically through estimation and threshold detection, those bands are “notched,” or removed, prior to creating the time-domain FMW using the appropriate inverse transform (e.g., inverse FFT). Data is then modulated with the FMW to generate the digitally encoded waveforms. Since the FMW is spectrally synthesized to specifically avoid interference regions, transmitted communication symbols do not contain any energy at spectral interference locations and received symbols are largely unaffected.

Accordingly, a feature of the embodiments of present invention is to combine spectrum sharing with the ability to operate in the presence of other interference without being detected, thereby offering a secure data link.

Another feature of the embodiments of the present invention is to provide for an adaptive interference mitigation capability inherent in TDCS making it a strong contender for use in sensor networks with 10 to 10,000 sensors within a limited geographic region where space-time coding of the sensor nodes could be very effective.

Other features and advantages will be apparent in light of the following detailed description and accompanying drawings.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 is a block diagram of the TDCS transmitter according to an embodiment of the present invention;

FIG. 2 is a block diagram of the TDCS Phase Generation and Mapping process according to an embodiment of the present invention;

FIGS. 3a-b illustrate the Binary CSK Waveform s₁(t) and s₂(t) according to an embodiment of the present invention;

FIG. 3c illustrates the Auto-Correlation s₁(t) according to an embodiment of the present invention;

FIG. 3d illustrates the Cross-Correlation of s₁(t) and s₂(t) according to an embodiment of the present invention;

FIG. 4 is a block diagram of the TDCS receiver according to an embodiment of the present invention;

FIG. 5 illustrates TDCS performance of antipodal and CSK modulations according to an embodiment of the present invention;

FIG. 6a illustrates an environmental snapshot of BFSK system operating at f_{c}=15.0 Hz according to an embodiment of the present invention;

FIG. 6b illustrates the TDCS usable spectrum for the BFSK spectrum of FIG. 6 according to an embodiment of the present invention;

FIG. 7 illustrates interference suppression performance due to variation in notch filter width applied in TDCS according to an embodiment of the present invention;

FIG. 8 illustrates spectral sharing for TDCS antipodal and BFSK systems according to an embodiment of the present invention;

FIG. 9 illustrates spectral sharing for TDCS CSK and BFSK systems according to an embodiment of the present invention;

FIG. 10a illustrates an environmental snapshot with multiple BFSK and BPSK systems according to an embodiment of the present invention;

FIG. 10b illustrates the resultant TDCS usable spectrum avoiding BFSK and BPSK systems of FIG. 10a according to an embodiment of the present invention;

FIG. 11 illustrates spectrum sharing of TDCS, BFSK and BPSK systems according to an embodiment of the present invention;

FIG. 12 illustrates a frequency hopping BFSK (FH-BFSK) spectrum user according to an embodiment of the present invention;

FIG. 13 illustrates FH-BFSK and TDCS spectral sharing with perfect sychronization according to an embodiment of the present invention;

FIG. 14 illustrates FH-BFSK and TDCS spectral sharing with FMW generation delay according to an embodiment of the present invention;

FIG. 15 illustrates the performance of FH-BFSK in an asynchronous dynamic environment according to an embodiment of the present invention; and

FIG. 16 illustrates the performance of TDCS in an asynchronous dynamic environment according to an embodiment of the present invention.

### DETAILED DESCRIPTION

In the following detailed description of illustrative embodiments, reference is made to the accompanying drawings that form a part hereof, and in which is shown by way of illustration, and not by way of limitation, specific embodiments in which the invention may be practiced. It is to be understood that other embodiments may be utilized and that changes may be made without departing from the spirit and scope of the present invention.

Interference mitigation and the ability to reliably communicate in the presence of interference are important in all communication applications. In general, interference is mitigated at the receiver using some type of filtering and/or spectral spreading techniques. The fundamental idea behind TDCS is to “avoid” interference at the transmitter by not putting waveform energy at corrupted spectral locations. Assuming the receiver can then be designed to only “look” in the locations containing energy, desired signal energy loss due to filtering and receiver complexity can be reduced. In one embodiment, the TDCS architecture assumes both the transmitter and receiver are observing the same electromagnetic environment and thus produce similar spectral estimates and notches (i.e., identical estimates in the ideal case). In this embodiment, the channel is assumed to be fixed Additive White Gaussian Noise (AWGN). The identical observed environment assumption is suitable for short-range data link applications where the transmitter and receiver are in the same interference environment. There are a number of military and commercial scenarios where this “local” assumption is valid. One example is a group of aircraft flying in close formation with the interference remotely located outside the formation.

In one embodiment, the FMW is the fundamental building block in TDCS processing and can be represented as a sum of weighted sinusoids as shown in Equation 1. Both Aᵢ and ωᵢ are deterministic in this case, i.e., their values are pre-determined depending on spectral occupancy choice and desired signal energy, whereas θᵢ is an arbitrary phase between 0 and 2 π.

$$b ( t ) = {\sum }_{i = 1}^{N} {A}_{i} exp [ j ( {ω}_{i} t + {θ}_{i} ) ] = {\sum }_{i = 1}^{N} {b}_{i} ( t ) 0 \leq t \leq T \qquad ( 1 )$$

In Equation 1, bᵢ(t) is the i^{th} FMW sinusoidal component where amplitude Aᵢ=A which is constant for all frequencies, ωᵢ is radian frequency of each tone, N is the number of frequencies, T is symbol duration, and θᵢ is phase. For the FMW, both Aᵢ and ωᵢ are deterministic given their values are a function of desired spectral occupancy and energy. However, phase θᵢ is considered arbitrary with uniform, independent identical distribution over [0, 2π].

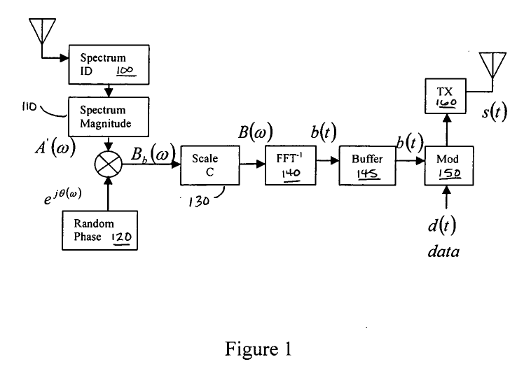

Functional TDCS implementation involves environmental sampling, spectral estimation, thresholding, notching, phase generation, phase mapping and inverse transformation to obtain the time-domain FMW of Equation 1. FIG. 1 is a block diagram of one embodiment of a TDCS transmitter showing the functional flow of TDCS signal generation and transmission, beginning with environmental sampling and spectral estimation. Given the “clean” or interference-free spectral regions are established, the FMW b(t) is generated, stored, data modulated and transmitted.

Spectrum identification is performed in block 100. This block determines the interference-free spectral regions. If interference is due to other cooperative systems, prior knowledge can be used to establish their spectral characteristics. In the case of non-cooperative interference, spectral estimation techniques can be used to establish an interference-free spectrum. A cooperative system is defined here as a legitimate user operating in the assigned spectral region whereas a non-cooperative system is a jammer. Examples of the spectral estimation techniques that may be used are periodogram, autoregressive (AR) and wavelet based techniques but any suitable spectral estimation technique may be used.

The spectrum magnitude is calculated in block 110 from the spectral estimate determined in block 100. To avoid interfering frequency components, a hard limiting threshold is applied. The threshold value is usually based on the mean of the spectrum. Applying a threshold to the estimated spectrum generates a “clean” or interference free spectrum A′(ω). Amplitudes of interfering frequency components exceeding the threshold are set to zero, or “nulled,” and the remainders of the spectral components are assigned a value of one.

The main difference between the analytic expression of the FMW in Equation 1 and the FMW implementation in the present invention is the random phase, performed in block 120. Since a truly random phase is not practical for receiver synchronization purposes, TDCS generates a pseudorandom (PR) phase. In this block, a multi-valued complex pseudorandom phase vector is generated for element-by-element multiplication with A′(ω) to produce the complex spectrum, B_{b}(ω). The application of a PR phase vector ensures that the time domain FMW has correlation properties similar to that of sampled noise. Linear Feedback Shift Registers (LFSR) can be configured to generate a maximum length, binary, PR sequence.

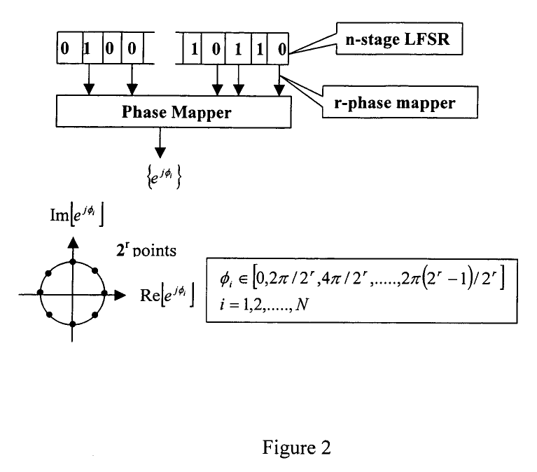

As shown in FIG. 2, each r-bit snap shot mapped of an m-sequence is mapped to one of 2^{r} complex phases. The m-sequence serves two important functions, 1) the PR phase generated is critical in the development of noise-like TDCS symbols, and 2) multiple access is implemented by assigning each user pair a unique primitive polynomial for a different m-sequence.

Returning to FIG. 1, magnitude scaling is performed in block 130. The complex spectrum is scaled appropriately to provide desired energy in the signal spectrum, B(ω). This scaling effectively permits all communication symbols to be transmitted with equal energy, i.e., for spectrum notching due to interference, the desired energy is distributed equally among all remaining components. Note that for those applications where peak-to-average power ratio (PAPR) of the resultant time domain waveform is a concern, as experienced and researched in relation to some Orthogonal Frequency Division Multiplexing (OFDM) applications, several coding techniques have been developed to provide desired power relationships. The effects experienced by the FMWs generated from TDCS processing may be similar to those of OFDM such that OFDM compensation techniques may be applicable to TDCS processing.

Block 140 generates the time-domain FMW b(t) by taking the appropriate inverse transform of the spectrally encoded frequency components. In one embodiment, the inverse transform is inverse fast Fourier transform (IFFT⁻¹) but any suitable inverse transform may be used. The resultant FMW contains energy only in the interference-free spectrum, and will be used by the modulator of block 150 to generate communication symbols. The resultant FMW b(t) is stored in the memory buffer in block 145 and used by the modulator for subsequent data modulation. Regeneration of a new FMW depends on operational requirements and environmental changes. For example, in a rapidly changing environment, generation of the FMW would occur more frequently than a benign or stationary environment.

Modulation is performed in block 150. Using the FMW, TDCS processing may employ either binary or M-ary modulation. Two binary modulations methods are considered, namely, antipodal signaling and a form of orthogonal modulation called Cyclic Shift Keying (CSK). Antipodal modulation is a form of signaling where binary signals are the negative of each other as shown in Equation 2. The CSK modulation technique takes advantage of noise-like FMW properties, i.e., correlation of time-shifted versions of the FMW with itself approaches zero. Based on this, TDCS CSK modulation uses circular shifts of the FMW to represent different symbols. For Binary CSK (BCSK), the first symbol s₁(t) is the FMW itself and the second symbol, s₂(t), is generated by circularly shifting the FMW over one-half its symbol period Tₛ as shown in Equation 3. This circular shift in the time domain induces a linear phase shift in the frequency domain without affecting the magnitude. The s[(t−T/M)]_{T} notation in Equation 3 is introduced to represent a circular shift of s(t) by one-M^{th} its symbol period T (M=2 for binary case)

$$\begin{matrix}{s}_{1} ( t ) = {\sum }_{i = 1}^{N} A exp ( j ( {ω}_{i} t + {θ}_{i} ) ) 0 \leq t \leq T & ( 2 ) \\ {s}_{2} ( t ) = - {s}_{1} ( t ) & \\ {s}_{2} ( t ) = {{s}_{1} [ ( t - T / 2 ) ]}_{T} & ( 3 )\end{matrix}$$

In general, two energy signals are orthogonal if and only if their inner product satisfies conditions of Equation 4. This is used to analytically show CSK orthogonality in Equation 5 through Equation 6 using two FMWs, s₁ and s₂ as described in (1), with A₁=A₂=A.

$$\begin{matrix}{x}_{ij} = \frac{1}{T} \int {x}_{i}^{*} ( t ) {x}_{j} ( t ) ⅆ t = \{ \begin{matrix}1 & for i = j \\ 0 & otherwise\end{matrix} \} & ( 4 ) \\ {s}_{12} = \frac{{A}^{2}}{T} {\sum }_{i = 1}^{N} {\sum }_{k = 1}^{M} {\int }_{0}^{T} exp ( - j ( {ω}_{i} t + {θ}_{i} ) ) exp ( j ( {ω}_{k} t + {ω}_{k} T / 2 + {θ}_{k} ) ) ⅆ t & ( 5 )\end{matrix}$$

Regrouping i≠k and i=k terms, the i≠k terms of s₁₂ go to zero for ωᵢ=2πi/T and

$$\begin{matrix}\begin{matrix}{s}_{12} = \frac{{A}^{2}}{T} {\sum }_{i = 1}^{N} {\sum }_{k = 1 , k \neq i}^{M} {\int }_{0}^{T} exp ( - j ( {ω}_{i} t + {θ}_{i} ) ) \\ exp ( j ( {ω}_{k} t + {ω}_{k} T / 2 + {θ}_{k} ) ) ⅆ t + \\ \frac{{A}^{2}}{T} {\sum }_{m = 1}^{N} {\int }_{0}^{T} exp ( j ( {ω}_{m} T / 2 ) ) ⅆ t\end{matrix} & \\ {s}_{12} = {A}^{2} {\sum }_{m = 1}^{N} exp ( jπ m ) = {A}^{2} {\sum }_{m = 1}^{N} cos ( π m ) + j sin ( π m ) & ( 6 )\end{matrix}$$

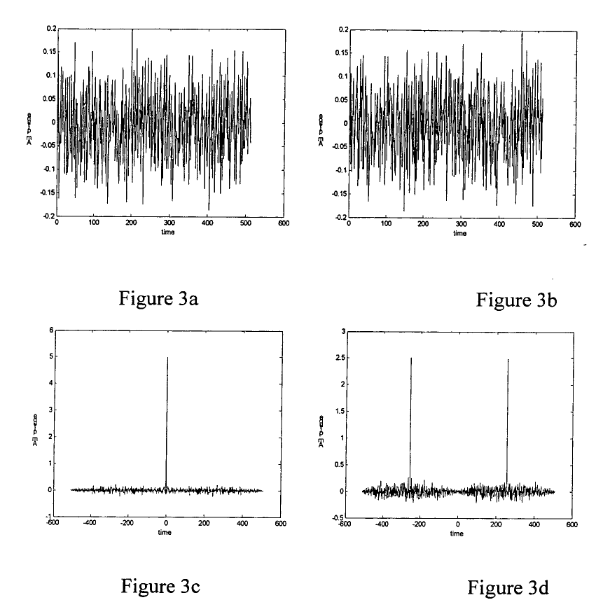

From Equation 6, it is seen that binary CSK (BCSK) waveforms are orthogonal (s₁₂=0) if N is chosen as even. FIGS. 3a and 3b show the noise-like BCSK FMWs of s₁(t) and s₂(t) (cyclically shifted s₁), respectively. FIGS. 3c and 3d show corresponding auto (identical for s₁ and s₂) and cross correlation (s₁₂) of the two CSK symbols. FIG. 3_{d} shows that at time (τ=0) s₁₂ approaches zero demonstrating CSK waveform orthogonality.

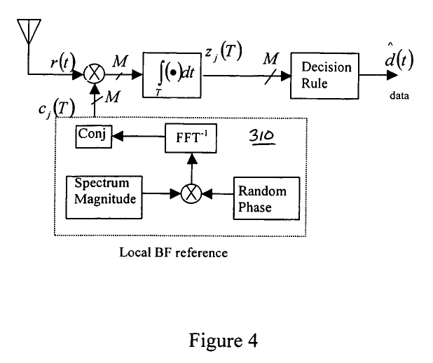

FIG. 4 is a block diagram of the TDCS receiver. The dotted-lined box 310 encloses the identical FMW generation process used by the transmitter. Received signal r(t) is comprised of the transmitted signal s(t), channel noise n(t), and if present, interference i(t). Signal r(t) is correlated with locally generated reference signals cⱼ(T), for the binary modulation (M=2). There is one locally generated reference for each possible symbol.

$$\begin{matrix}{Z}_{j} ( t ) = {\int }_{0}^{T} r ( t ) * {c}_{j} ( t ) ⅆ t & ( 7 ) \\ {\hat{d}}_{j} ( t ) = {d}_{j} ( t ) {\vert}_{max [ {Z}_{j} ( T ) ]} for j = 1 , 2 , … , M & ( 8 ) \\ {P}_{b} = Q ( \sqrt{\frac{α {E}_{b}}{{N}_{0}}} ) & ( 9 )\end{matrix}$$

The ML rule of (14) is applied to correlator test statistics Zⱼ(t) of Equation 7 to estimate transmitted data. For identical electromagnetic environments, i.e., identical FMWs generated by transmitter and receiver, a fixed AWGN channel and static interference during signal duration, bit error rate (BER), P_{b}, for orthogonal and antipodal signaling using coherent matched filter detection is given by Equation 9 for α=1 and α=2, respectively, where E_{b} is average energy per bit, N₀ is noise power density and Q(·) is the complementary error function.

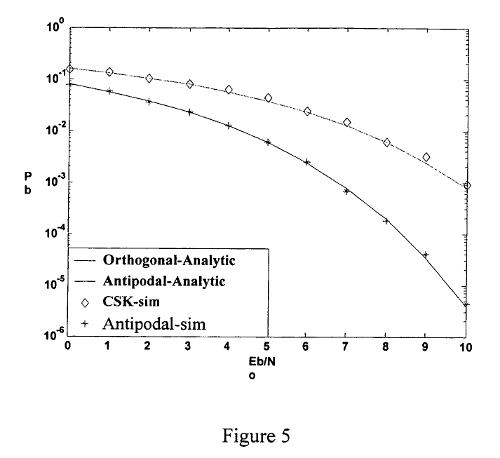

In FIG. 5, the theoretical and simulated TDCS performance of TDCS in an AWGN channel with no interference present is illustrated. The solid antipodal and dashed orthogonal curves are theoretical values from Equation 9. The ‘Antipodal-sim’ and ‘CSK-sim’ and data points are simulated BER for TDCS using antipodal and CSK modulations of Equation 2 and Equation 3, respectively. Under perfect synchronization and identical spectral estimation conditions, the simulation results closely match analytic BER performance of Equation 9.

### Spectral Coexistence

Spectrum sharing or spectral coexistence is defined as multiple systems having the ability to 1) detect each other in a given spectral region and then 2) dynamically alter their power, frequency, modulation, etc., to efficiently utilize vacant spectrum while inducing minimal or manageable interference to other(s). Two cases of spectrum sharing are considered here, static and dynamic. In a static environment the spectrum occupancy at a given geographic location does not change over time, whereas in a dynamic environment the spectrum occupancy changes over time. For the static environment, systems are modeled as using Binary Frequency Shift Keying (BFSK) and Binary Phase Shift Keying (BPSK) modulations. Theoretical P_{b} for coherent detection of BFSK and BPSK over and AWGN channel is given by Equation 9 for α=1 and α=2, respectively. For the dynamic environment, a system using Frequency Hopping BFSK (FH-BFSK) is introduced.

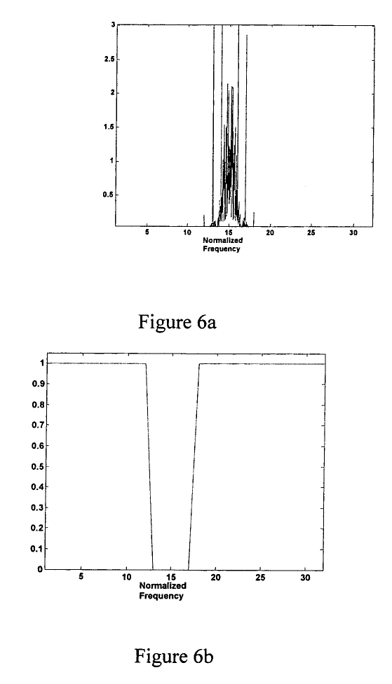

FIG. 6a shows a static environment with one BFSK system operating at a center frequency (f_{c}) equal to 15 Hz. FIG. 6b illustrates how TDCS adaptively creates the usable spectrum by notching out the BFSK spectrum. The notch width depends on the spectral estimation and thresholding techniques used in the spectrum magnitude block 110 of FIG. 1. Spectral estimation and adaptive notching are important elements for minimizing TDCS interference to coexistent users. To date, autoregressive (AR), periodogram and wavelet-based spectral estimation techniques have been successfully employed in TDCS research but other suitable techniques of spectral estimation may be used.

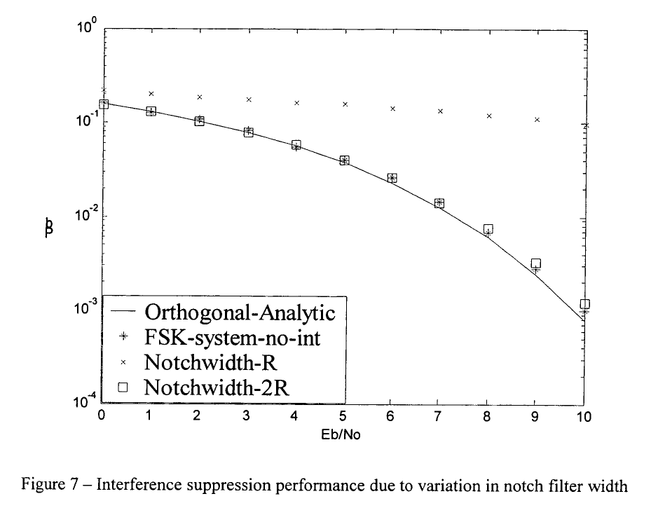

FIG. 7 illustrates TDCS interference to other existing systems in the spectral environment. In this scenario, the other existing user is modeled using an FSK modulation. In this figure, theoretical FSK is represented by ‘Othogonal-Analytic’, FSK system in the absence of TDCS interference is represented by ‘FSK-system-no-int’ and ‘Notchwidth-R’ and ‘Notchwidth-2R’ represents TDCS interference to FSK system. Notchwidth-R and Notchwidth-2R represents a notching filter with a bandwidth of ‘R’ (data rate of FSK) and ‘2R’ ( twice the data rate of FSK). As TDCS increases its notchwidth from ‘R’ to ‘2R,’ its interference to the existing FSK system decreases. In order to minimize spectral interference as well as increase the TDCS bandwidth, a more robust and adaptive notching and spectral shaping technique will be determined.

### Static Single User Environment

Spectral sharing BFSK and TDCS BER results were generated using the BFSK spectral environment of FIG. 6a and resultant TDCS spectral notch of FIG. 6b as created with AR estimation and thresholding. The TDCS system was modeled using each of the binary modulation techniques described earlier (i.e., Antipodal and CSK). The other coexisting system in the environment is modeled as BFSK modulation. The BFSK and TDCS signal power levels were set to establish an E_{b}/Nₒ=30 dB when acting as interference to the other system.

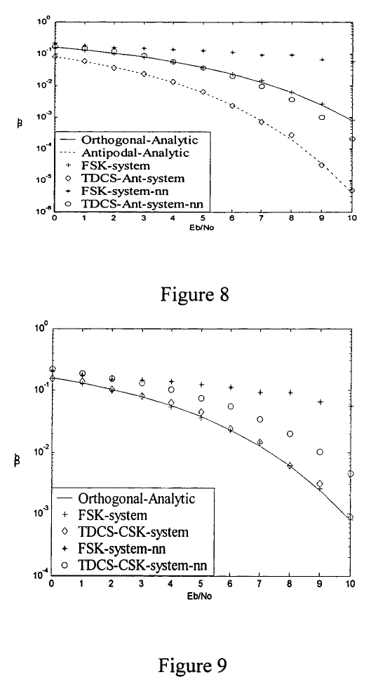

FIG. 8 shows BER performance for the TDCS using antipodal modulation (TDCS-Ant) and the BFSK system, where 1) ‘FSK-system’ and ‘TDCS-Ant-system’ represent simulated BER curves for BFSK and TDCS antipodal systems with the spectral notch of FIG. 6b applied, 2) ‘FSK-system-nn’ and ‘TDCS-Ant-system-nn’ are simulated BER curves without spectral notching applied, and 3) ‘Analytic’ curves were obtained using Equation 9. As indicated in the figure, when the TDCS employs spectral notching, BFSK frequencies are avoided and simulated results for both systems closely match analytic approximations for scenarios containing no interference present. As also indicated, when the TDCS does not employ spectral notching, e.g., the TDCS is somehow unaware that the BFSK system is present and does not form a spectral notch, both systems experience performance degradation. The TDCS degradation approaches that of narrowband interference and the BFSK degradation approaches that of wideband interference.

Similarly, the BER performance of TDCS using CSK (TDCS-CSK) and BFSK systems are shown in FIG. 9, where 1) ‘FSK-system’ and ‘TDCS-CSK-system’ represent simulated BER for BFSK and TDCS CSK systems with the spectral notch of FIG. 6b, and 2) ‘FSK-system-nn’ and ‘TDCS-CSK-system-nn’ are simulated BER without spectral notching applied. Given that both TDCS-CSK and BFSK are orthogonal modulations, there is only one analytic BER curve in FIG. 9 as given by Equation 9 for α=1. Similar to FIG. 8 results, the performance of both TDCS-CSK and BFSK degrade when TDCS does not employ notching.

### Static Multiple User Environment

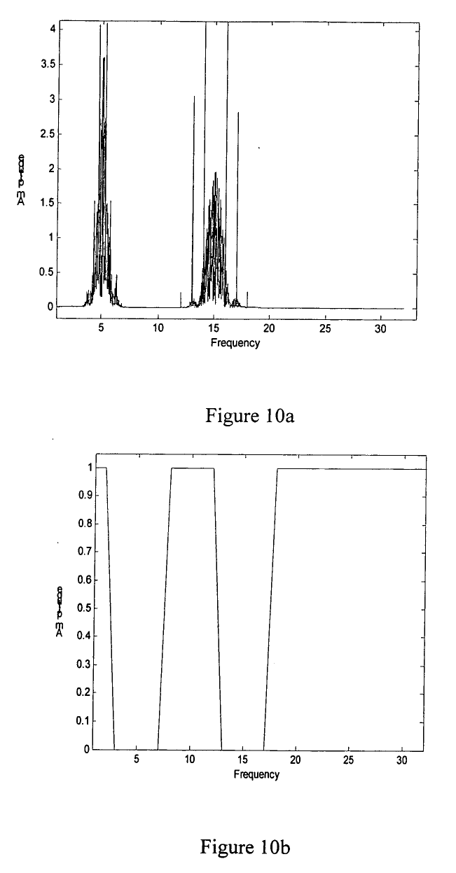

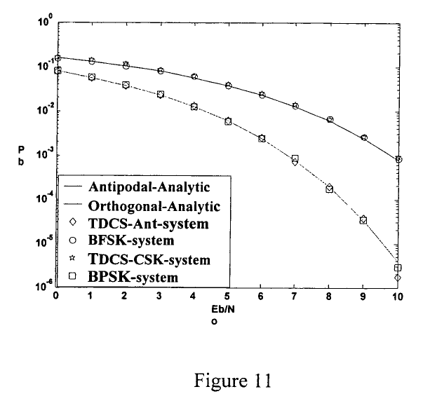

This case introduces multiple systems into the environment to coexist with TDCS. FIG. 10a shows the spectrum consisting of two responses resulting from BPSK and BFSK systems with f_{c}=5 and f_{c}=15, respectively. FIG. 10b shows the resultant TDCS spectral notch generated to avoid interference. Analytic P_{b} expressions of Equation 9 for BPSK and BFSK are the same as TDCS antipodal and CSK signaling, respectively. Spectrum sharing results are shown in FIG. 11 for the case where TDCS employs spectral notching. The ‘Antipodal-Analytic’ data in FIG. 11 is for comparison with both BPSK and TDCS-Ant modulations and the ‘Orthogonal-Analytic’ data is for comparison with BFSK and TDCS-CSK. As in the previous environment, the AR based notch of FIG. 10b used by the TDCS enables all three systems to coexist with virtually no performance degradation.

### Dynamic Environment

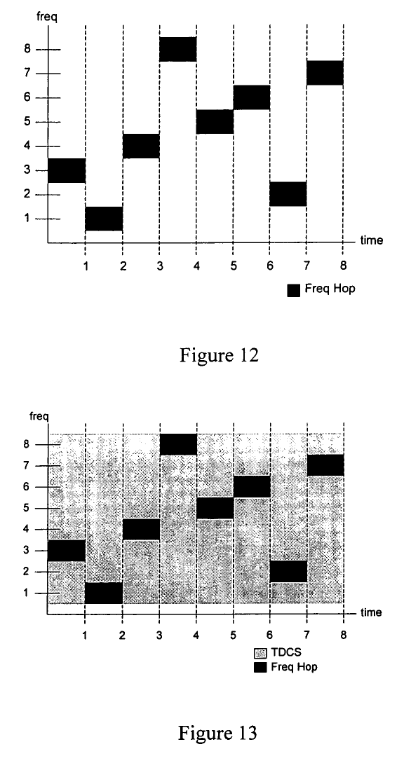

The dynamic environment is modeled as containing two systems, the TDCS and a Frequency Hopper using BFSK data modulation (FH-BFSK). As shown in FIG. 12, the spectrum was divided into eight frequency bins with the FH-BFSK system randomly hopping in accordance with a pseudorandom code. The hop rate is 100 bits/hop which is sometimes referred to as slow hopping and thus for a data rate of 3 K bits/sec the hop rate is 30 hops/sec.

Two dynamic environment cases were considered. In both cases, the TDCS is assumed to have a priori knowledge of the FH-BFSK hopping pattern such as the sequence and ordering of hop frequencies. However, in the first case the TDCS is perfectly time synchronized with the FH-BFSK system and in the second case it is not. The spectral response for the synchronized case is shown in FIG. 13 where the gray box represents TDCS spectral occupancy as a function of time and black boxes represent FH-BFSK occupancy. In this case, perfect synchronization implies that when the FH-BFSK system hops to a new center frequency, the TDCS adapts in a timely fashion such that a new FMW is generated which perfectly matches FH-BFSK characteristics and ideal spectrum sharing is achieved.

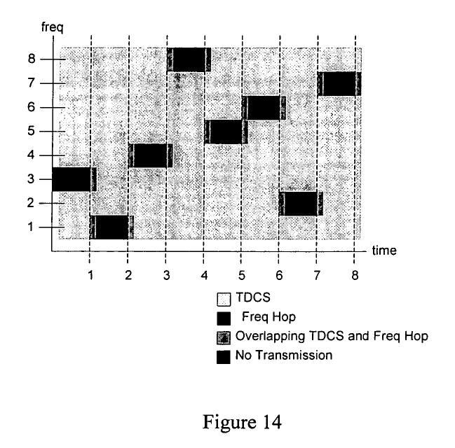

For the second asynchronous scenario, the TDCS again has a priori knowledge yet it is not perfectly synchronized, i.e., as the FH-BFSK system hops to a new center frequency, the TDCS system experiences a delay in FMW generation and thus uses a previous FMW for current environmental conditions. This delay results in mutual TDCS/FH-BFSK interference for a duration equaling the time it takes the TDCS to generate a current FMW. The effect of this delay is illustrated in FIG. 14 where unshaded regions with horizontal lines are unused spectrum and those with diagonal lines are areas of mutual interference. Thus, the delayed TDCS response has resulted in 1) unused spectral regions and 2) increased mutual interference regions.

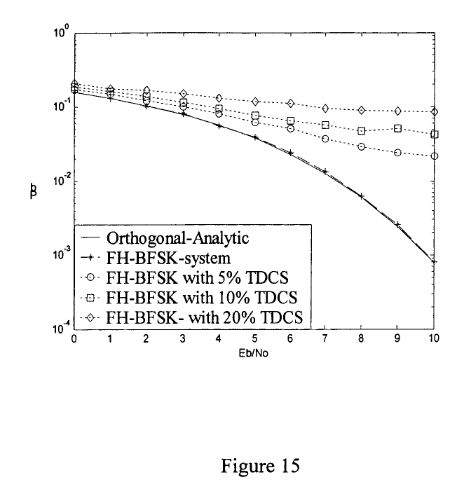

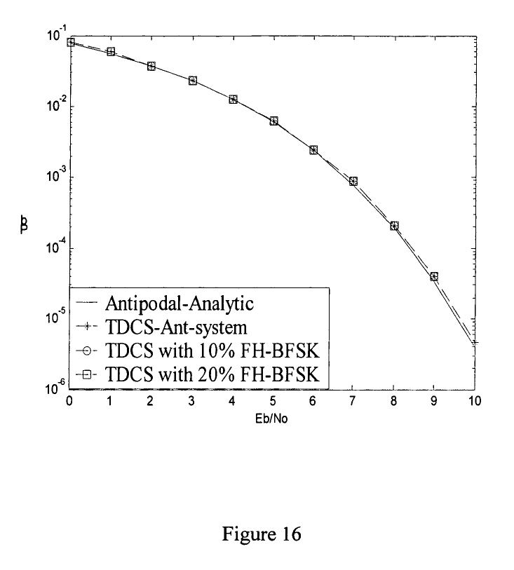

Performance of FH-BFSK in the presence of a TDCS system is shown in FIG. 16. When both systems are perfectly synchronized as in FIG. 13, the BER of ‘FH-BFSK-system’ follows the analytic results. When TDCS experiences some delay (represented as a percentage of hop rate) in adapting to the new spectral environment, as shown in FIG. 14, the TDCS induces more interference into the FH-BFSK system for the duration of the delay. The resultant FH-BFSK performance degradation is shown in FIG. 15 as ‘FH-BFSK with 5% TDCS’, ‘FH-BFSK with 10%’ TDCS and ‘FH-BFSK with 20% TDCS’, corresponding to delay values of 5%, 10% and 20% of the hop rate, respectively. The figure clearly shows that FH-FSK performance is severely impacted with as little as 5% delay in FMW estimation and utilization. Corresponding TDCS performance in the presence of the FH-BFSK system under these same conditions is shown in FIG. 16. From FIG. 6 results it is evident that TDCS performance is minimally affected by FH-BFSK interference resulting from delayed FMW generation. The reason behind the performance degradation differences can be linked to fundamental system operation. For the FH-BFSK system, the TDCS acts as broadband interference during interfering time intervals and spans the entire FH-BFSK spectrum. Whereas, the FH-BFSK system acts as partial band interference and only a portion of the TDCS spectrum is affected. One potential solution for mitigating TDCS interference to FH-BFSK systems under these conditions might involve the introduction of guard time during FMW generation.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A method for spectrum re-use employing transfer domain communications systems, the method comprising:
sampling electromagnetic environmental conditions;
estimating spectral interference from said electromagnetic environmental conditions;
identifying frequency bands containing strong spectral interference;
notching said identified frequency bands from said spectrum;
creating a fundamental modulation waveform from said notched spectrum;
generating digitally encoded waveforms by modulating communication data with said fundamental modulation waveform;
transmitting said digitally encoded waveform to a receiver; and
receiving said digitally encoded waveform and interpreting said digitally encoded waveform at said receiver to receive said communication data.

2. The method for spectrum re-use employing transfer domain communications systems of claim 1, further comprising:
storing said fundamental modulation waveform; and
re-using said fundamental modulation waveform during subsequent generation of digitally encoded waveforms.

3. The method for spectrum re-use employing transfer domain communications systems of claim 1, further comprising:
adapting said digitally encoded waveform by repeating the steps of estimating spectral interference and creating a fundamental modulation waveform for modulating communication data when changes in said electromagnetic environmental conditions occur.

4. The method for spectrum re-use employing transfer domain communications systems of claim 1, wherein said fundamental modulation waveform is the sum of weighted sinusoids.

5. The method for spectrum re-use employing transfer domain communications systems of claim 1, wherein identifying said frequency bands is by a form of threshold detection.

6. The method for spectrum re-use employing transfer domain communications systems of claim 1, wherein estimating spectral interference comprises using Fourier transformation, periodogram, autoregression, wavelet based or combinations thereof.

7. The method for spectrum re-use employing transfer domain communications systems of claim 1, wherein said notching is accomplished by inverse transformation.

8. The method of claim 7, wherein said inverse transformation includes inverse discrete Fourier Transform, inverse wavelet transform, or combinations thereof.

9. A method of transmitting a communication signal for a spectrum re-use employing transfer domain communications system, the method comprising:
identifying a spectrum;
calculating an interference free spectrum by determining regions that are interference-free and applying a threshold value;
determining a magnitude of said interference free spectrum;
generating a pseudorandom phase vector;
multiplying said pseudorandom phase vector element by element with said magnitude of said interference free spectrum to produce a complex spectrum;
scaling the magnitude of said complex spectrum to provide the desired signal energy in a signal spectrum, wherein said scaling ensures that all communication signals are transmitted with substantially equal energy;
generating a fundamental modulation waveform by taking the inverse transformation of the frequency components of said complex spectrum;
generating a digitally encoded communication signal through data modulation of communication data to be transmitted with said fundamental modulation waveform; and
transmitting said digitally encoded communication signal to a receiver.

10. The method of transmitting a communication signal for a spectrum re-use employing transfer domain communications system of claim 9, further comprising:
regenerating a new fundamental modulation waveform when electromagnetic environmental conditions change.

11. The method of transmitting a communication signal for a spectrum re-use employing transfer domain communications system of claim 9, further comprising:
regenerating a new fundamental modulation waveform based on operational requirements.

12. The method of transmitting a communication signal for a spectrum re-use employing transfer domain communications system of claim 9, wherein determining interference-free regions is established through using prior knowledge of spectral characteristics when said communication system is considered to be cooperative.

13. The method of transmitting a communication signal for a spectrum re-use employing transfer domain communications system of claim 9, wherein determining interference-free regions is established through spectral estimation techniques when said communication system is considered to be non-cooperative.

14. The method of transmitting a communication signal for a spectrum re-use employing transfer domain communications system of claim 13, wherein said spectral estimation techniques comprise Fourier Transformation, periodogram, autoregression, wavelets, or combinations thereof.

15. The method of transmitting a communication signal for a spectrum re-use employing transfer domain communications system of claim 9, wherein calculating said interference free spectrum further comprises:
setting amplitudes of interfering frequency spectrum components exceeding said threshold value to a value of zero; and
assigning remaining frequency spectrum components that do not exceed said threshold value to a value of one.

16. The method of transmitting a communication signal for a spectrum re-use employing transfer domain communications system of claim 9, wherein said threshold value is approximately the mean of said spectrum.

17. The method of transmitting a communication signal for a spectrum re-use employing transfer domain communications system of claim 9, wherein a maximum length, binary pseudorandom sequence is generated by configured linear feedback shift registers in combination with a r-bit phase mapper, wherein said maximum length, binary pseudorandom sequence is used to generate said pseudorandom phase vector.

18. The method of transmitting a communication signal for a spectrum re-use employing transfer domain communications system of claim 9, wherein said fundamental modulation waveform contains energy only in said interference free spectrum.

19. The method of transmitting a communication signal for a spectrum re-use employing transfer domain communications system of claim 9, further comprising:
storing said fundamental modulation waveform; and
re-using said fundamental modulation waveform during modulation of subsequent communication signals until electromagnetic environmental changes occur.

20. The method of transmitting a communication signal for a spectrum re-use employing transfer domain communications system of claim 19, wherein said fundamental modulation waveform is stored in a memory buffer of said transmitter.

21. The method of transmitting a communication signal for a spectrum re-use employing transfer domain communications system of claim 9, wherein said data modulation comprises a binary scheme, a M-ary scheme, or combinations thereof to transmit data.

22. The method of transmitting a communication signal for a spectrum re-use employing transfer domain communications system of claim 21, wherein said binary modulation comprises antipodal signaling, orthogonal signaling, or combinations thereof.

23. The method of transmitting a communication signal for a spectrum re-use employing transfer domain communications system of claim 22, wherein said antipodal signaling comprises Binary Phase Shift Keying signaling, wherein binary waveforms are negative of each other.

24. The method of transmitting a communication signal for a spectrum re-use employing transfer domain communications system of claim 22, wherein said orthogonal signaling comprises Cyclic Shift Keying, wherein said Cyclic Shift Keying is quasi-orthogonal modulation.

25. A method of receiving a digitally encoded communication signal from a transmitter in a spectrum re-use employing transfer domain communications system, the method comprising:
generating a fundamental modulation waveform at a receiver;
correlating locally generated reference signals of said generated fundamental modulation waveform with said digitally encoded communication signal received from said transmitter; and
estimating the digitally encoded data transmitted by said digitally encoded communication signal by applying a maximum likelihood rule.

26. A system for spectrum re-use employing transfer domain communications systems, the system comprising:
a transmitter, wherein said transmitter transmits a digitally encoded communication signal employing transfer domain communications by estimating spectral interference in a spectrum, removing regions of said spectral interference from said spectrum, modulating said interference free spectrum with a calculated fundamental modulation waveform to generate said digitally encoded communication signal to be transmitted; and
a receiver, wherein said receiver generates a local fundamental modulation waveform and correlates said local fundamental modulation waveform with said received digitally encoded communication signal from said transmitter to determine the data of said digitally encoded communication signal.

27. The system for spectrum re-use employing transfer domain communications systems of claim 26, wherein said transmitter and said receiver have the capability to share spectral information.

28. The system for spectrum re-use employing transfer domain communications systems of claim 26, wherein said system operates in a static single user environment.

29. The system for spectrum re-use employing transfer domain communications systems of claim 26, wherein said system operates in a static multiple user environment.

30. The system for spectrum re-use employing transfer domain communications systems of claim 26, wherein said system operates in a dynamic environment.
